(19) United States
(12) Patent Application Publication
(10) Pub. No.: US 2015/0178708 A1
(43) Pub. Date: Jun. 25, 2015

(54) DYNAMIC PAYMENT PROCESSING GATEWAY WITH RULES BASED PAYMENT PROCESSING ENGINE

(71) Applicant: Maxim Reutov, Arlington, MA (US)

(72) Inventor: Maxim Reutov, Arlington, MA (US)

(21) Appl. No.: 14/575,838

(22) Filed: Dec. 18, 2014

Related U.S. Application Data
(60) Provisional application No. 61/918,220, filed on Dec. 19, 2013.

(51) Int. Cl. G06Q 20/22; G06Q 20/40

(52) U.S. Cl. CPC G06Q 20/227; G06Q 20/405

(57) ABSTRACT

Payment processing systems and gateways are configured to (a) accept payment transactions from a merchant in a plurality of disparate formats, (b) convert payment transaction to a format recognized by a payment gateway, (c) use a rules based engine to determine a first third party payment processor to process a payment transaction, and (d) convert the payment transaction into a format acceptable to the determined first third party payment processor.

### CROSS REFERENCE TO RELATED APPLICATIONS

This application claims priority to and the benefit of the filing date of U.S. Provisional Application No. 61/918,220, filed on Dec. 19, 2013, entitled “DYNAMIC PAYMENT PROCESSING GATEWAY WITH RULES BASED PAYMENT PROCESSING ENGINE”, which is hereby incorporated by reference in its entirety including its appendix.

### FIELD OF THE INVENTION

The present invention relates to the field of computer implemented payment processing systems. More particularly, in some embodiments, the present invention relates to computer implemented methods and systems to process payments using multiple disparate third party payment processing providers.

### BACKGROUND OF THE INVENTION

The number of households and offices with electronic devices such as computers and smart phones has increased exponentially throughout the past few decades. In the United States alone, over 76% of all households reported having at least one computer in the 2011 US Census Report, and in many countries this number is even higher. The marketplace for buying goods and services has undergone a dramatic shift with millions of users worldwide now buying their products online. In fact, the global online retail sector had total revenues of $631.7 bn in 2012, representing a compound annual growth rate (CAGR) of 18.6% between 2008 and 2012.

Providers of goods and services (sometimes referred to herein as “merchants” or “retailers”) have traditionally utilized third party payment processing providers to process debit and credit card payments online. Such third party payment processing providers offer simplicity and convenience in exchange for a small processing fee. All third party credit card processing systems have different application program interfaces (APIs) that frequently have nothing in common except that they can process credit card payments. Usually, an online retailer will choose the most reliable and popular payment processor that they can afford and hire a developer to write integration code. Such integration is usually very tightly coupled to the online shopping card and inventory management system so once online retailer integrates with one payment processing provider, then it is very complicated to switch to another system. Virtually all third party payment processing providers guarantee 99.99% or more system availability (uptime), but there is still that 0.01% or more chance that the payment processing provider may be offline or unresponsive; for example when they have to perform system maintenance and updates. Even a 10 minute interruption can lead to significant loss of money for online retailers not to mention the negative customer experience which occurs after a failed online transaction.

Payment processing systems are different in terms of reliability and fees that they charge. Some of the most reliable systems such as PayPal™ may charge the greatest fees, while less known systems, such as Litle™ may charge smaller fees. It can be a complicated choice for an online retailer to select such system. Additionally, because of the different fee structures offered by each payment processing provider (payment processor), an online merchant may be able to save money by routing certain transactions to one payment processor while sending other transactions to a different payment processor. It would also be useful to be able to send payment transactions to a different payment processor if the primary payment processing provider is offline or unresponsive. However, as noted above, once a payment processing provider is chosen, it is often difficult and not practical to move to a different payment processor after the first processor has been fully integrated within an online merchant's system.

There is therefore a need in the field for new computer implemented methods and systems to allow retailers to integrate their online merchant systems with multiple (i.e. more than one) third party payment processing providers. There is further a need in the field for new computer implemented methods and system to allow online retailers to send sales transactions to different third party processing providers based on rules which may be customized by the retailer. It would further be advantageous to provide a payment processing system capable of accepting and storing payment transaction 1900 for processing at a later time in the event that a third party payment processing provider is offline or unresponsive thereby preventing lost sales for the merchant.

### BRIEF SUMMARY OF THE INVENTION

In some embodiments, it is one aspect to provide a novel payment processing gateway configured to (a) accept payment transaction 1900 from a merchant in a plurality of disparate formats, (b) convert payment transaction 1900 to a format recognized by a payment gateway, (c) use a rules based engine to determine a first third party payment processor to process a payment transaction, and (d) convert payment transaction into a format acceptable to the determined first third party payment processor.

### BRIEF DESCRIPTION OF THE DRAWINGS

Some embodiments of the present invention are illustrated as an example and are not limited by the figures of the accompanying drawings, in which like references may indicate similar elements and in which:

FIG. 1A shows a broad overview of the layers involved with typical payment processing system as commonly found in the prior art.

FIG. 1B shows a broad overview of the layers involved with typical payment processing gateway as commonly found in the prior art.

FIG. 2 provides an illustrative example showing a broad overview of the layers involved with payment processing gateway and system according to embodiments described herein.

FIG. 3 is a block diagram showing an example of a server which may be used by the system as described in various embodiments herein.

FIG. 4 is a block diagram illustrating an example of a client device or machine which may be used by the system as described in various embodiments herein.

FIG. 5 shows a block diagram of components, modules, and engines of a system in accordance with some embodiments of the present invention.

FIG. 6 shows a flow chart illustrating transaction processing workflow for a payment gateway and rules engine as described in various embodiments herein.

FIG. 7 shows a flow chart illustrating some computer implemented methods and processes which may be run by a payment gateway rules engine and by the system as described in various embodiments herein.

FIG. 8 shows a flow chart illustrating some computer implemented methods and processes which may be run by an API conversion engine as described in various embodiments herein.

FIG. 9 shows a flow chart illustrating some computer implemented methods and processes which may be run by a failover payment processor module as described in various embodiments herein.

FIG. 10 shows an example of a graphical user interface (GUI) which may be used by the system and payment processor configuration module to allow a user to select and configure one or more third party payment processors as described in various embodiments herein.

FIG. 11 shows an example of a graphical user interface (GUI) which may be used by the system and rules creation module to allow a user to select and configure one or more rules used by the rules engine as described in various embodiments herein. An example of an active rule is shown along with a sample rank order of third party payment processors.

FIG. 12 provides an example of various hardware components and users that may be configured to work with the system in accordance with some embodiments of the present invention.

FIG. 13 provides an example of computer implemented processes for a local integration service according to embodiments of the present invention to integrate components of the present invention with a merchant's payment system by replacing the url of a third party payment processor with a local url allowing components of the present invention to accept and facilitate the processing of payment transactions without the need for the merchant to add substantial amount of additional code or make extensive changes to their payment system.

FIG. 14 provides an example of computer implemented processes for an API conversion engine according to embodiments of the present invention to integrate components of the present invention with a merchant's payment system.

FIG. 15 provides an example computer implemented processes within a local integration service according to embodiments of the present invention.

FIG. 16 provides an example of some computer implemented processes for a second/third format translation engine module and a code mapping engine according to embodiments of the present invention.

FIG. 17A provides an example of a confirmation response containing a transaction result code as may be received from a third party payment processor's server in accordance with various embodiments described herein.

FIG. 17B provides an example of a confirmation response code mapping table as may be used by the system to classify transaction result codes into a transaction result code category for further processing by the payment gateway rules engine in accordance with various embodiments described herein.

FIG. 18 shows one example of computer implemented methods and processes that may be run by a code mapping engine in accordance with various embodiments described herein.

FIG. 19 shows several examples of payment transactions including payment transaction variables and payment transaction dependent variables in accordance with various embodiments described herein. Although the payment transactions are shown in a table format, any suitable format for sending and receiving data containing payment transaction 1900 is contemplated herein.

FIG. 20 provides one example of computer implemented methods and processes which may be employed by the system in accordance with various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

### DEFINITIONS

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a computer processor. Thus, the methods and systems of the present invention may be performed by a computer based on instructions received by computer software.

The term “client device” or sometime “electronic device” or just “device” as used herein is a type of computer generally operated by a person. Non-limiting examples of client devices include; personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device”. Some non-limiting examples of mobile devices include; cell phones, smart phones, tablet computers, laptop computers, wearable computers such as watches, Google Glasses, etc. and the like.

As used herein the term “data network” shall mean an infrastructure capable of connecting two or more computers such as client devices either using wires or wirelessly allowing them to transmit and receive data. Non-limiting examples of data networks may include the Internet or wireless networks or (i.e. a “wireless network”) which may include wifi and cellular networks.

As used herein, the terms “third party payment processor” 102, also known as “3^{rd} party payment processor”, “third party payment processing provider”, “payment processor”, “TPPP”, or similar derivations thereof shall generally mean an entity capable of accepting multiple forms of payments online (e.g. Visa credit cards, Visa debit cards, MasterCard credit cards, American Express credit cards, electronic checks, etc.), processing those payments through one or more financial intuitions, and crediting a merchant's account with a dollar amount for that transaction less any payment processing fees. Some non-limiting examples of third party payment processing providers include PayPal™ a wholly owned subsidiary of eBay, Inc. of San Jose, Calif. and Litle & Co. of Lowell, Mass.

As used herein the term “payment processor server” is a type of computer software configured to accept and process payment transactions for third party payment processors.

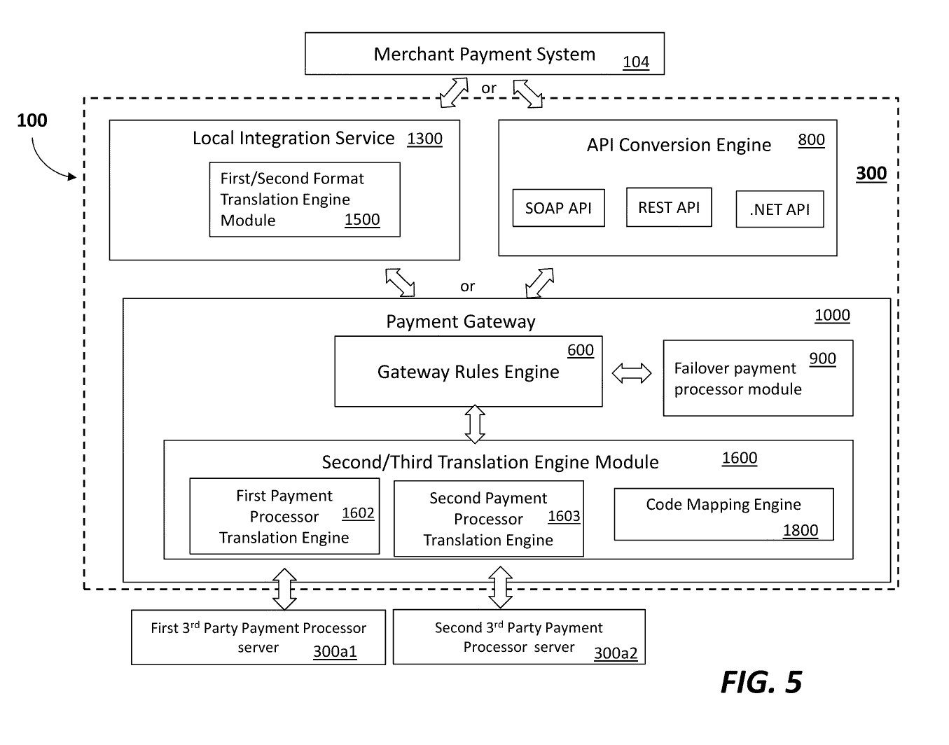

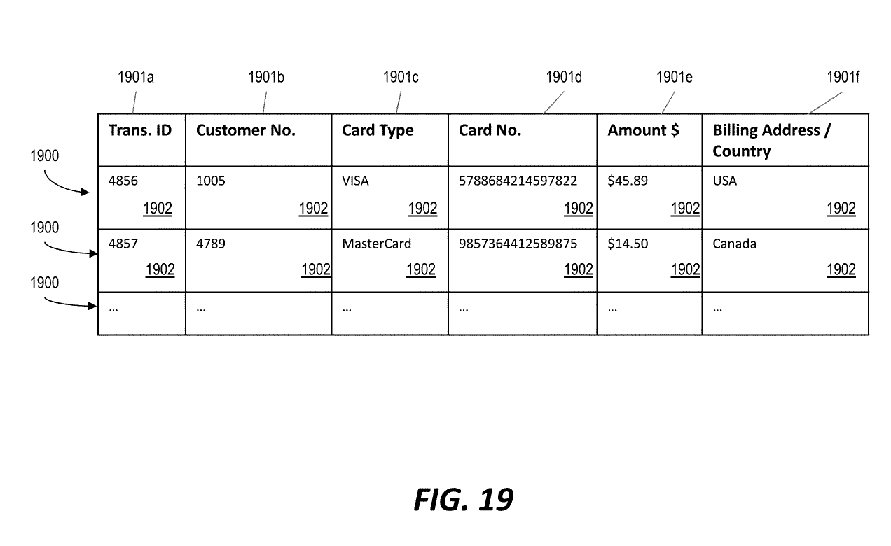

As used herein, the term “payment transaction 1900”, “payment transaction” 1900, “payment details” or sometimes just “transactions” (see for example 1900—FIG. 19) shall generally refer to information and multiple transaction dependent variables 1902 (FIG. 19) about a particular customer's purchase from a merchant. Payment transaction variables 1901 (FIG. 19) may include but are not limited to information such as; transaction id number 1901a (FIG. 19), customer name, customer billing address, customer billing address country 1901f (FIG. 19), customer credit or debit card type (e.g. Visa, MasterCard, AMEX, etc.) 1901c (FIG. 19), credit or debit card number 1901d (FIG. 19), credit or debit card expiration date, credit or debit card security code, transaction amount 1901e (FIG. 19), transaction date, item/product number, etc. When payment transaction 1900 are received from a customer on a merchant's website, they are typically within a format which may depend on the merchant's payment system 104 (FIG. 5) or API used by that merchant (i.e. “first API format” or “first format”). Payment transactions 1900 are preferably stored in a database on a data store 308 on a server 300 and may be accessed by the system 100.

As used herein the term “merchant's payment system” 104 shall generally refer to software or programs 316 run by a merchant 101(b) on a server 300 to accept digital orders for products and services from a consumer 101(a). Merchant's payment system 104 may sometimes be known as a shopping cart or online shopping cart system. Merchant's payment system 104 generally collects payment transaction dependent variables 1902 (FIG. 19) from the consumer 101(a) during the online shopping process.

As used herein the term “disparate” shall have its usual meaning of being different or dissimilar and in particular embodiments of the present invention allow a merchant to use disparate or different third party payment processors and disparate or different merchant payment systems 104 at the same time this providing an improvement over the prior art.

The present disclosure is to be considered as an exemplification of the invention, and is not intended to limit the invention to the specific embodiments illustrated by the figures or description below.

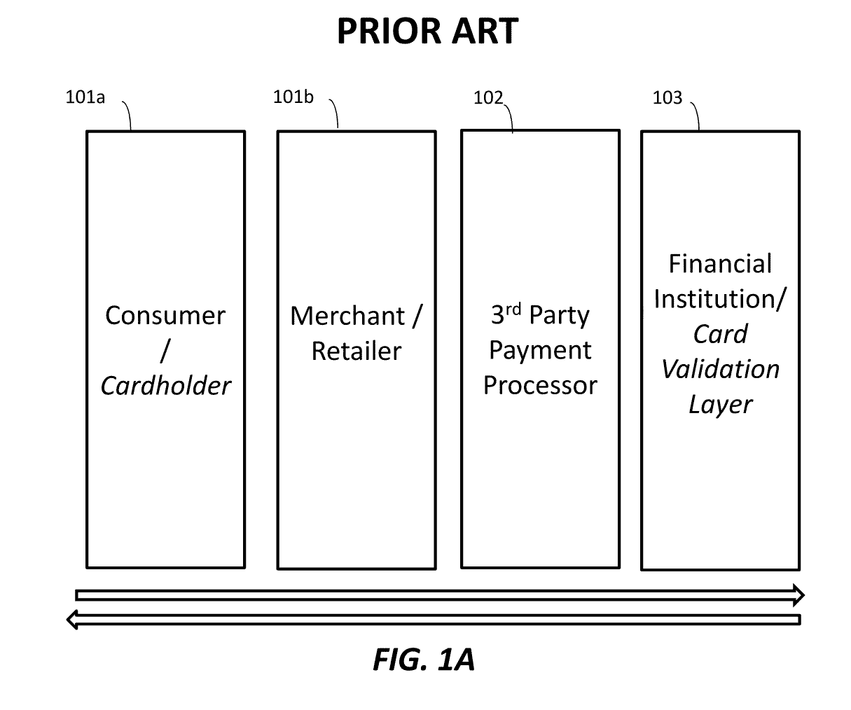

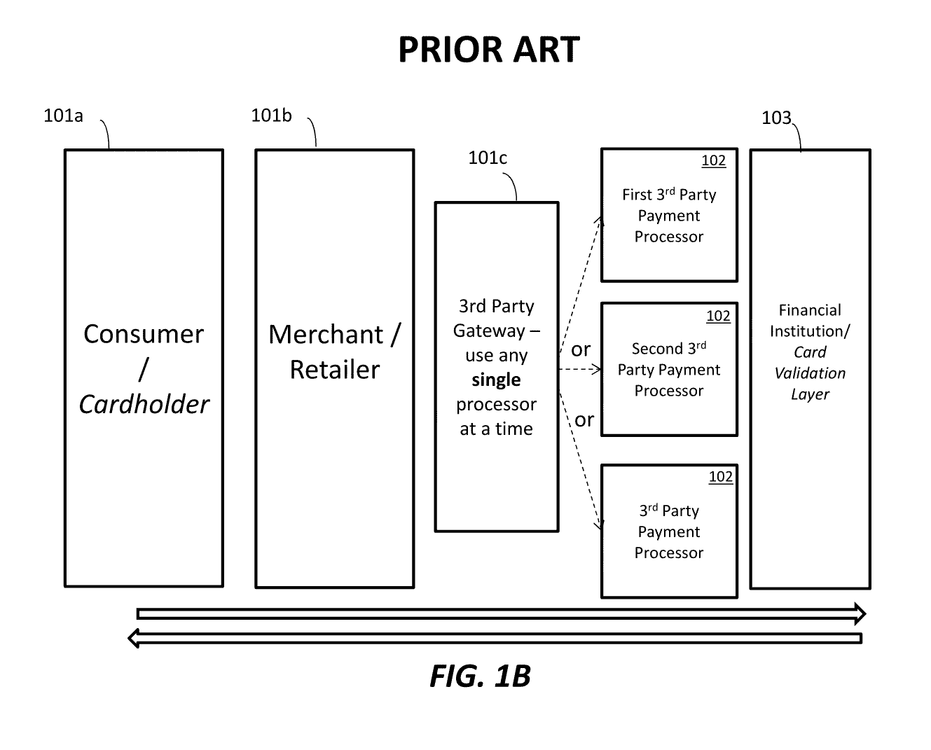

As perhaps best shown by FIG. 1A labeled as “PRIOR ART”, a block diagram is provided as a contemporary system overview showing various layers for processing payments online. As shown by this example, a consumer cardholder 101a purchases goods or services online from a merchant 101b using their debit or credit card. Merchant 101b receives and sends the consumer's payment transaction 1900 (FIG. 19) to a third party payment processor 102 directly (FIG. 1 is where merchant 101b integrates with third party payment processor 102 directly, without using gateway 101c (FIG. 1A)). The third party payment processor 102 may next validate the card with a financial institution 103, determine if there is available credit or balance for the purchase, and process the payment for the merchant. It should be noted in this example that there is a one-to-one relationship between the merchant 101b and the third party payment processor 102.

FIG. 1B is similar to FIG. 1A in that merchant 101b or retailer is able to accept and process payments through a third party payment processor 102, however, in this example the merchant 101b uses a third party payment gateway 101c to connect to the third party payment processor 102. However, unlike embodiments of the present invention, the third party payment gateway 101c is configured to connect merchant's payment system 104 (FIG. 5) with a single third party payment processor 102 at any given time. That is, the merchant 101b must first choose which third party payment processor 102 they desire to work with and then configure the third party payment gateway 101c to send payments to that chosen payment processor 102. These third party payment gateways 101c therefore allow a one-to-one relationship between the merchant payment system 104 and each third party payment processor 102.

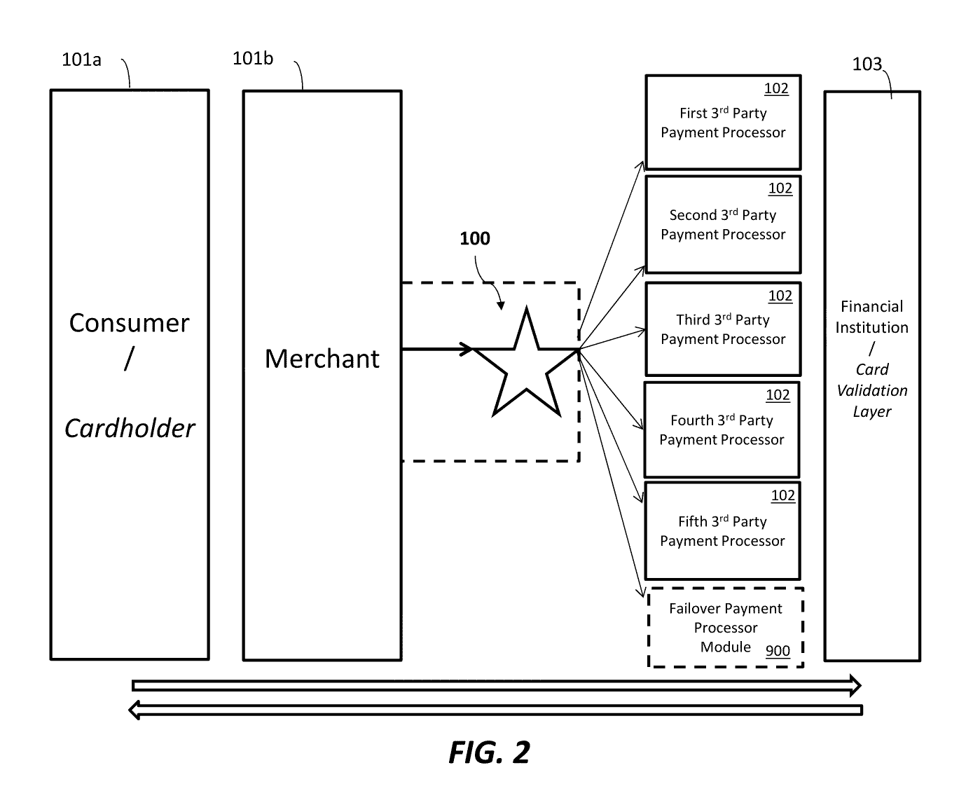

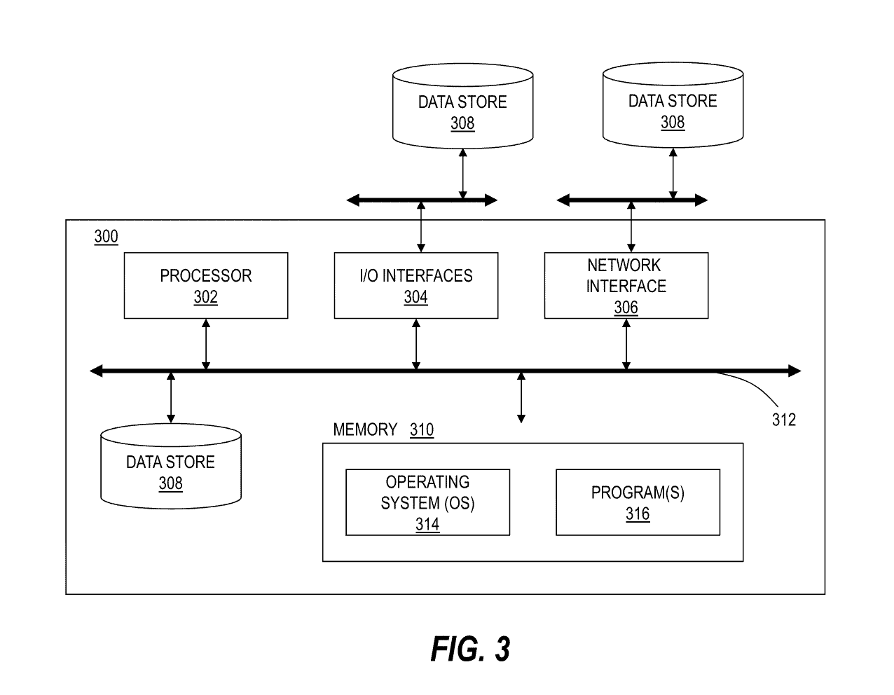

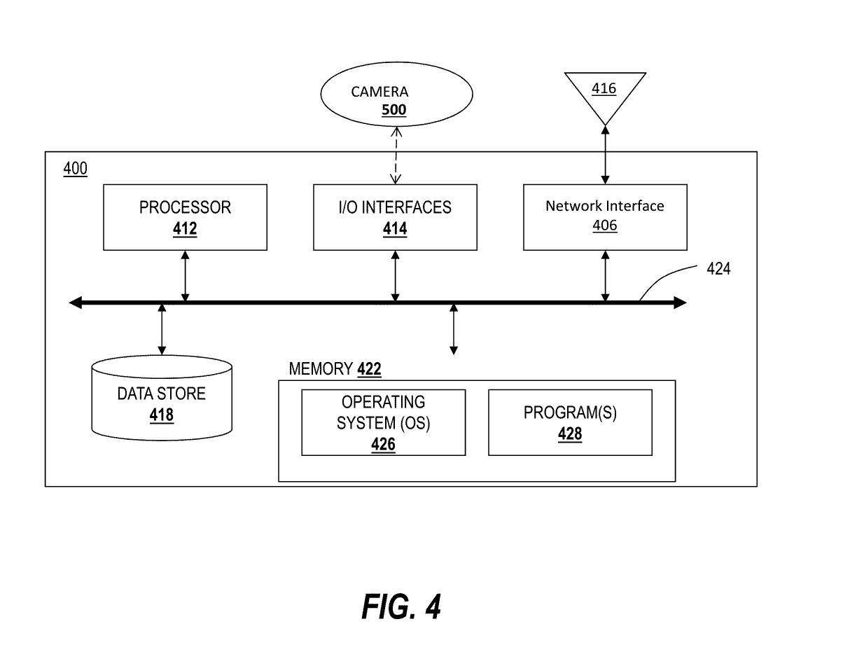

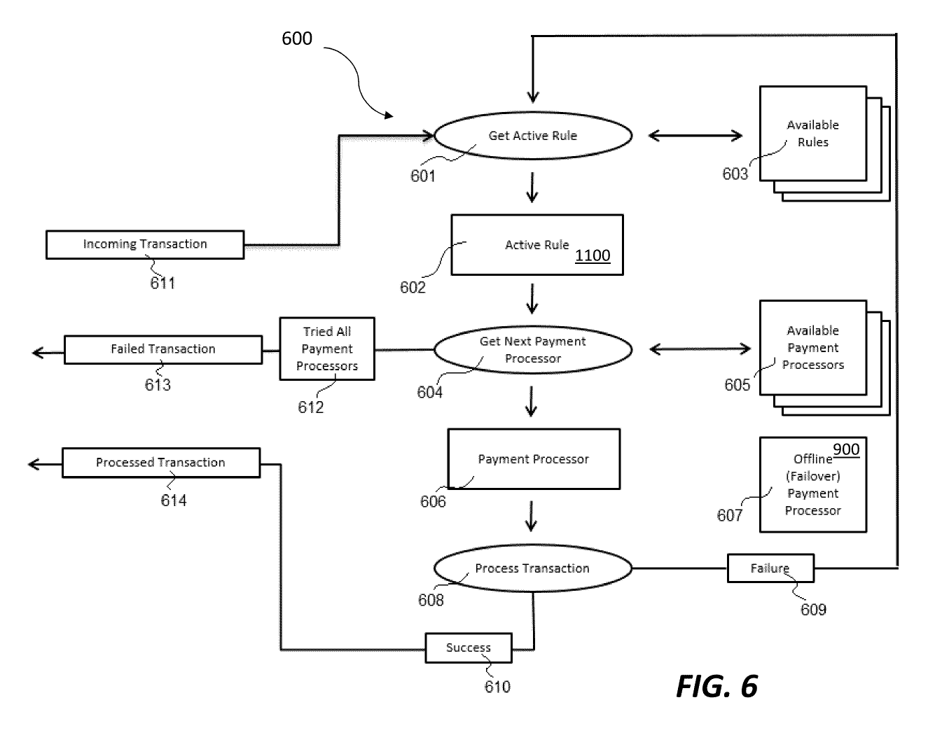

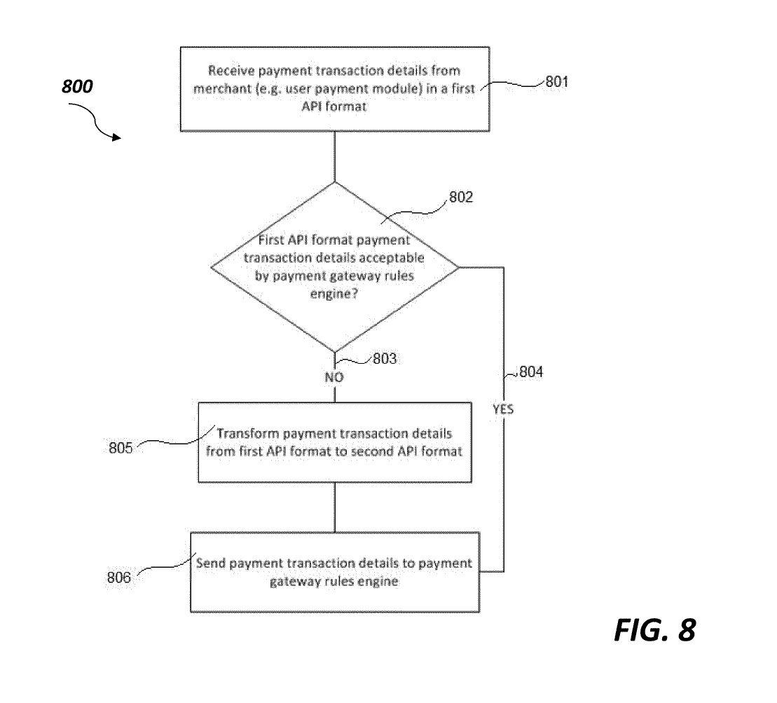

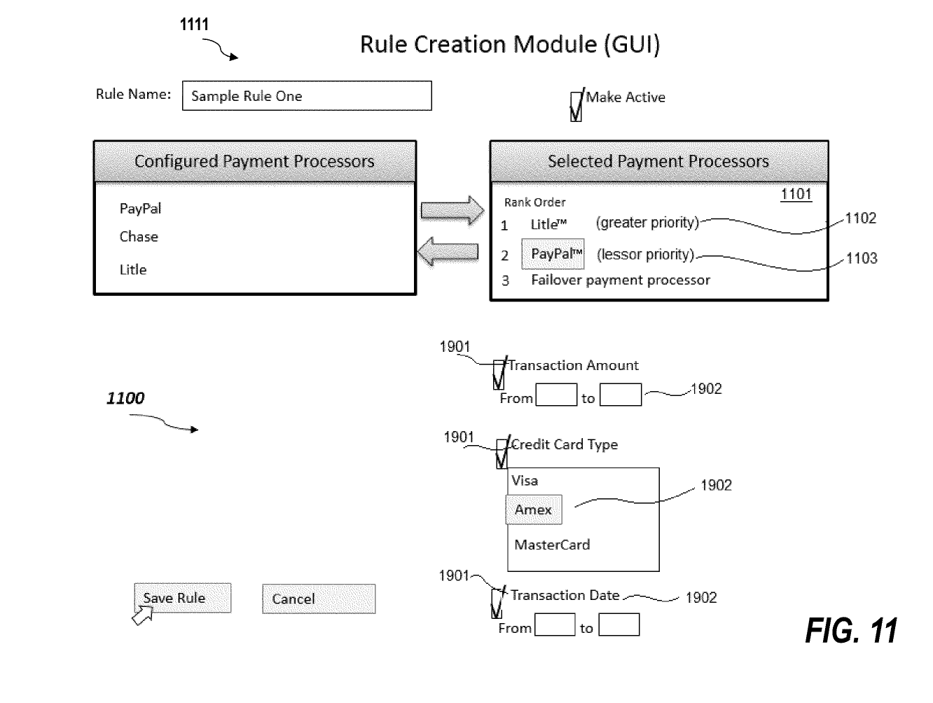

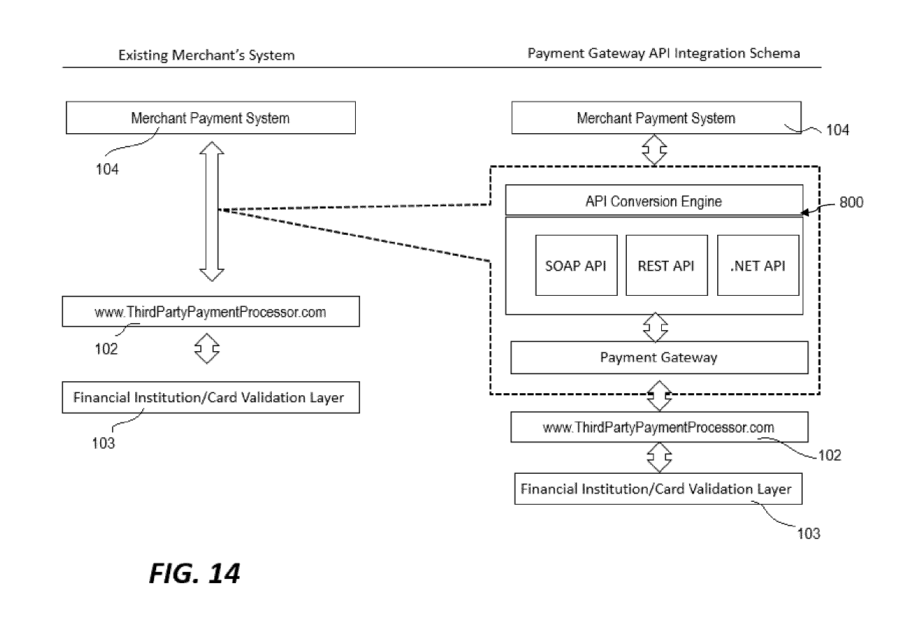

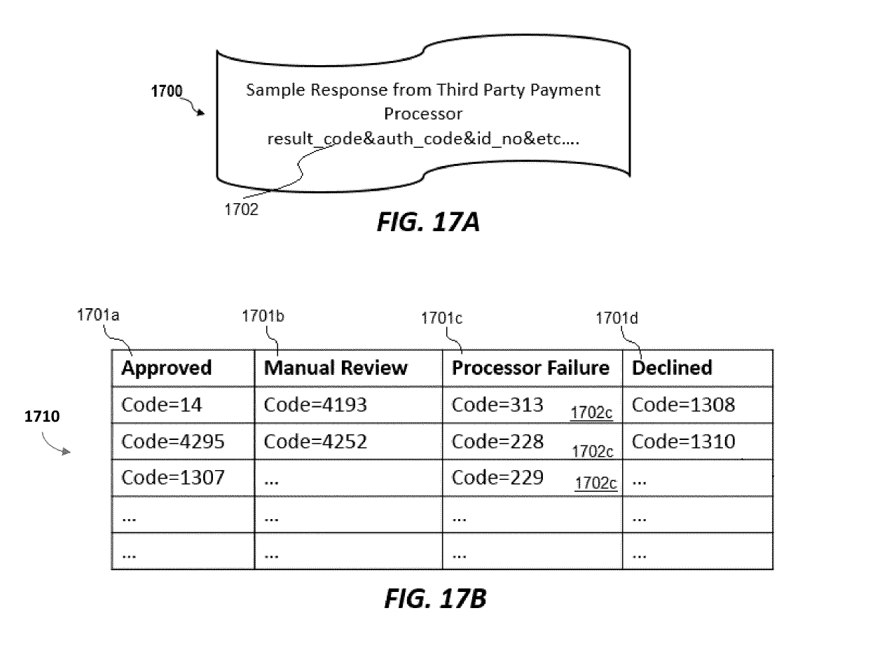

Referring now to FIG. 2, a block diagram is provided as an exemplary overview the system 100 which comprises a payment gateway 1000 (FIG. 5). In some embodiments, the system 100 comprises computer implemented methods and processes known as program 316 (FIG. 3) run on a server 300 (FIG. 3) or programs 428 (FIG. 4) run on one or more client devices 400 (FIG. 4)1. As shown by this example, a consumer cardholder 101a purchases goods or services online from a merchant 101b using their debit or credit card. In some embodiments of the present invention, merchant 101b receives the consumer's payment transaction 1900 through a merchant payment system 104 in a first API format or “first format”. The system 100 may converts this data with an API conversion engine 800 (FIGS. 8 and 14) or local integration service 1300 (FIGS. 5, 13, and 15) to a “second format” readable by the payment gateway 1000 and rules engine 600 (FIGS. 5 and 6). Using a payment gateway rules engine 600, selectively determine the appropriate third party payment processor 102 (from one or more configured third party payment processors 102) to process the payment transaction 1900, further converts the payment transaction 1900 to a canonical format accepted by the chosen third party payment processor server 300a (FIG. 5), and finally sending the payment transaction 1900 request to the third party payment processor 102, or, if a first third party payment processor 102 is unresponsive/times out or provides a processor failure result code 1702c (FIG. 17A and 17B), a second third party payment processor 102 will be selected by the rules engine 600 according to the payment gateway rules engine 600 rank order (FIG. 11), if all configured third party payment processors 102 are not responsive, timeout, or provide a processor failure result code 1702c, then transaction may be saved in a database on a data store 308 for later processing through a failover payment processor module 900. Upon receiving the payment transaction 1900, the third party payment processor server 300a selected by the system 100 (e.g. through the rules engine or rank order), may next validate the payment credit or debit card with a financial institution, determine if there is available credit or balance for the purchase, and process the payment for the merchant and send a payment confirmation response to the merchant 101b through the system 100. It should be noted that unlike third party payment gateways 101c shown in FIG. 1A, the system 100 of the present invention preferably allows a one-to-many relationship at any given time between the merchant payment system 104 and multiple third party payment processors 102.

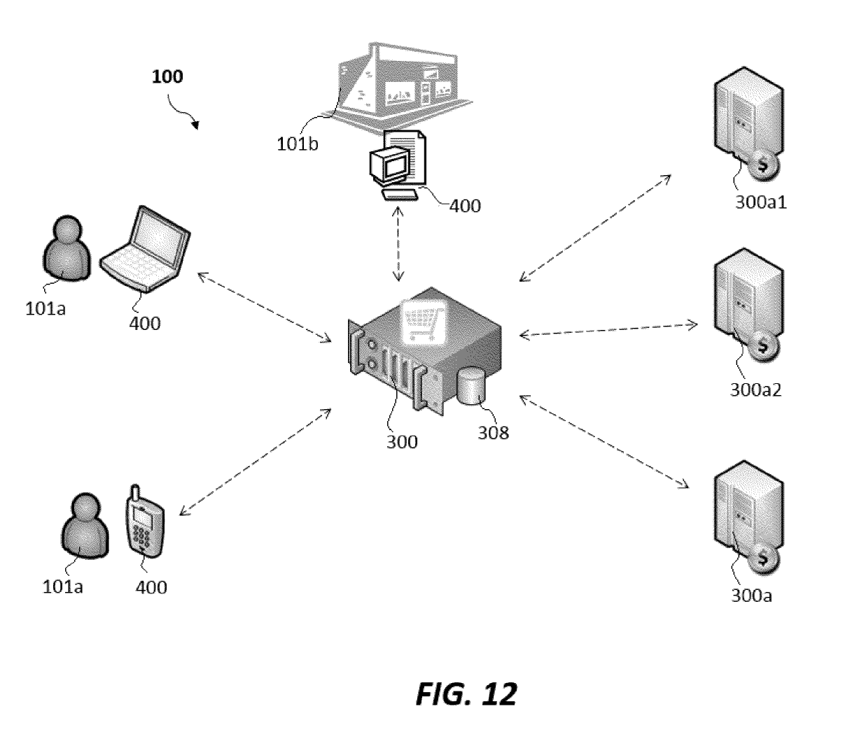

Referring now to FIG. 3, in an exemplary embodiment, a block diagram illustrates a server 300 such as a payment gateway server which may be used in the system 100 to run computer implemented processes, modules, and engines as described herein. It should also be noted that third party payment processors 102 will generally each have one or more third party payment processor servers 300a (FIGS. 5 and 12) configured to accept and process payment transactions 1900 (FIG. 19) from the system 100 and said third party payment processor servers 300a shall also be described in this section when referring to the server 300. It should also be noted that in preferred embodiments, modules, engines, and programs of the system 100 shall be run on the same server 300 or a server 300 local to the merchant's payment system 104. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions and in particular the processor 302 may be adapted to run merchant payment systems, API conversion engines, Local Integration Service, payment gateway rules engines, translation engines, payment processor configuration modules, rule creation modules, and other methods as described herein. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the WAN 101, the enterprise 200, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 316. The operating system 314 essentially controls the execution of other computer programs, such as the one or more programs 316, and provides scheduling, input-output control, file and data management, memory management, and communication control and related services. The operating system 314 may be, for example Windows NT, Windows 2000, Windows XP, Windows Vista, Windows 7, Windows 8, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 316 may be configured to implement the various processes, algorithms, methods, techniques, etc. described herein.

Referring to FIG. 4, in an exemplary embodiment, a block diagram illustrates a client device 400, which may be used in the system 100 or the like. The client device 400 can be a digital device that, in terms of hardware architecture, generally includes a processor 412, input/output (I/O) interfaces 414, a radio 416, a data store 418, and memory 422. It should be appreciated by those of ordinary skill in the art that FIG. 4 depicts the client device 410 in an oversimplified manner, and a practical embodiment may include additional components and suitably configured processing logic to support known or conventional operating features that are not described in detail herein. The components (412, 414, 416, 418, and 422) are communicatively coupled via a local interface 424. The local interface 424 can be, for example but not limited to, one or more buses or other wired or wireless connections, as is known in the art. The local interface 424 can have additional elements, which are omitted for simplicity, such as controllers, buffers (caches), drivers, repeaters, and receivers, among many others, to enable communications. Further, the local interface 424 may include address, control, and/or data connections to enable appropriate communications among the aforementioned components.

The processor 412 is a hardware device for executing software instructions and in particular the processor 412 may be adapted to run merchant payment systems, API conversion engines, Local Integration Service, payment gateway rules engines, translation engines, payment processor configuration modules, rule creation modules, and other methods as described herein. The processor 412 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 412 is configured to execute software stored within the memory 422, to communicate data to and from the memory 422, and to generally control operations of the client device 400 pursuant to the software instructions. In an exemplary embodiment, the processor 412 may include a mobile optimized processor such as optimized for power consumption and mobile applications. The I/O interfaces 406 can be used to receive user input from and/or for providing system output. User input can be provided via, for example, a keypad, a touch screen, a scroll ball, a scroll bar, buttons, bar code scanner, voice recognition, eye gesture, and the like. System output can be provided via a display device such as a liquid crystal display (LCD), touch screen, and the like. The I/O interfaces 414 can also include, for example, a serial port, a parallel port, a small computer system interface (SCSI), an infrared (IR) interface, a radio frequency (RF) interface, a universal serial bus (USB) interface, and the like. The I/O interfaces 406 can include a graphical user interface (GUI) that enables a user to interact with the client device 400. Additionally, the I/O interfaces 406 may further include an imaging device, i.e. camera, video camera, etc.

The radio 416 enables wireless communication to an external access device or network. Any number of suitable wireless data communication protocols, techniques, or methodologies can be supported by the radio 416, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 418 may be used to store data. The data store 418 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 418 may incorporate electronic, magnetic, optical, and/or other types of storage media.

In some preferred embodiments, the client device 400 includes a global positioning system sensor configured to receive latitude and longitude coordinates from satellites (i.e. a GPS signal).

In some other preferred embodiments, the client device 400 includes an accelerometer configured to receive user initiated actions (e.g. shaking the device, moving the device in a pattern, etc.).

The memory 422 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 422 may incorporate electronic, magnetic, optical, and/or other types of storage media. Note that the memory 422 may have a distributed architecture, where various components are situated remotely from one another, but can be accessed by the processor 412. The software in memory 422 can include one or more software programs, each of which includes an ordered listing of executable instructions for implementing logical functions. In the example of FIG. 4, the software in the memory system 422 includes a suitable operating system (O/S) 426 and programs 428. The operating system 426 essentially controls the execution of other computer programs, and provides scheduling, input-output control, file and data management, memory management, and communication control and related services. The operating system 426 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 428 may include various applications, add-ons, etc. configured to provide end user functionality with the client device 400. For example, exemplary programs 428 may include, but not limited to, a web browser, social networking applications, streaming media applications, games, mapping and location applications, electronic mail applications, financial applications, and the like. In a typical example, the end user typically uses one or more of the programs 428 along with a network such as the system 100.

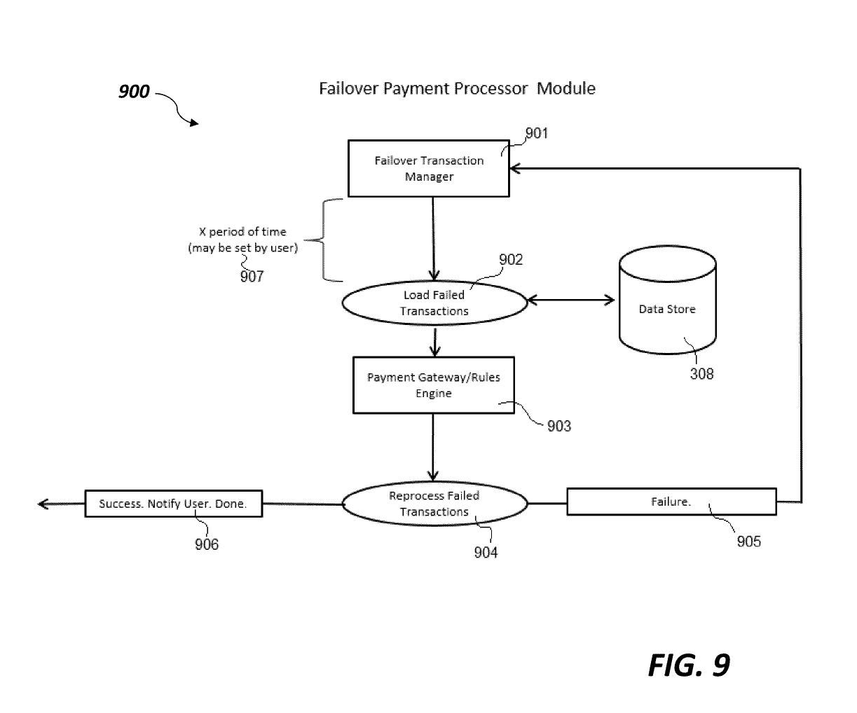

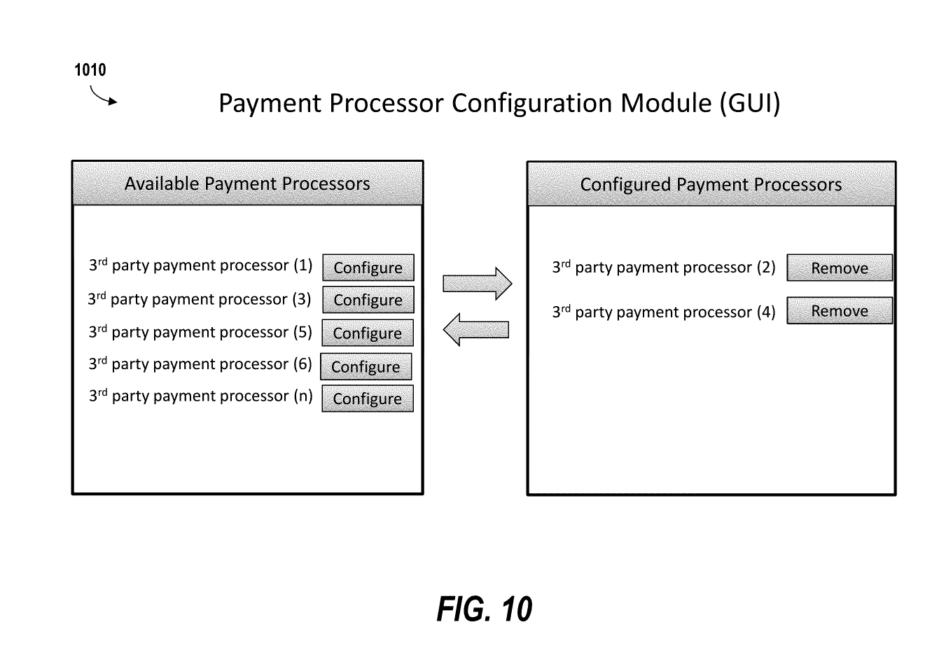

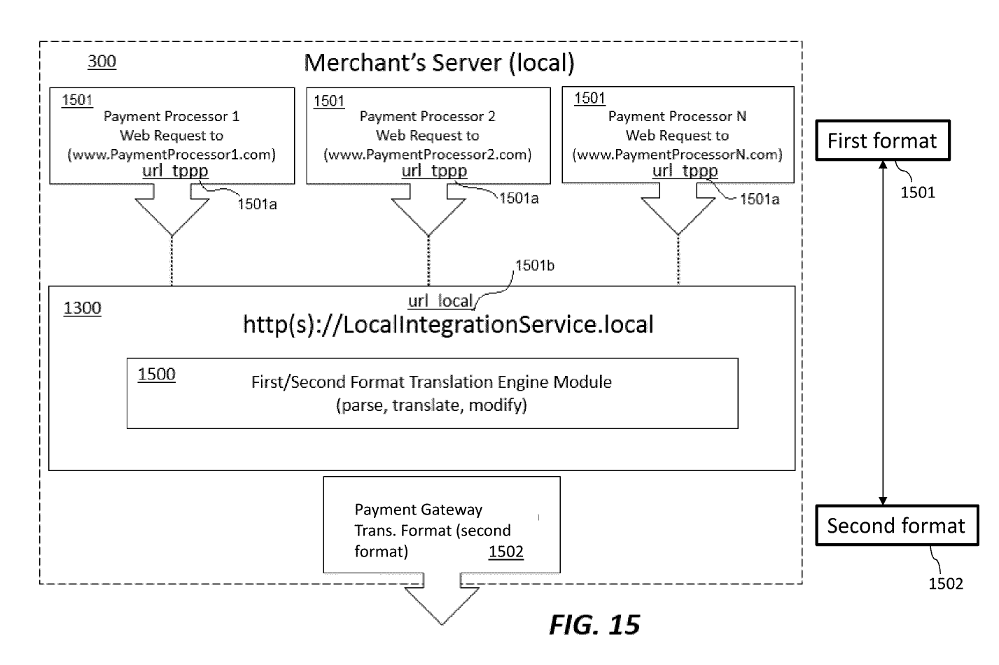

Referring now to FIG. 5, a high level overview of the payment processing system 100 is provided. In his example, a merchant payment system 104 is configured to receive a payment transaction 1900 (FIG. 19) from a consumer 101a through a merchant's website, mobile application, physical store location card processing machine, or other suitable payment receiving portal. In a some embodiments, after the merchant payment system 104 receives a payment transaction 1900 in a first format 1501 (FIG. 15) it sends this information to an API conversion engine 800 or to local integration service 1300 to be translated into a second format 1502 readable by the rules engine 600 or system 100. In one embodiment, the API conversion engine 800 allows the payment gateway rules engine 600 to be integrated with most merchant checkout and merchant payment systems 104 through from a variety of different APIs (SOAP, REST, .NET, etc.). In some embodiments, local integration service 1300 is able to communicate with a plurality of third party payment processors 102; it is responsible for converting requests from a first format 1501 that merchant's payment system 104 uses to communicate with a third party payment processor 102 to a second format 1502 supported by the system 100 and vice versa. In this example, the gateway rules engine 600 receives a transaction from the API conversion engine 800 or local integration service 1300 and is configured to run one or more logic based rules also known as a plurality of rules 603 (FIG. 6) which may be setup by a user in a rules configuration module (FIG. 11) to determine and select the appropriate third party payment processor 102 from a list of configured processors which may be configured using a payment processor configuration module (FIG. 10). Next, translation engine(s) (if needed) convert payment transaction 1900 into the appropriate canonical format according to the rule selected payment processor 102 and send the payment transaction 1900 to the selected first third party payment processor 102. If selected first third payment processor is unresponsive or times out for a period of time (e.g. 100 ms, 500 ms, 1 s, 5 s, 10 s, 20 s, 30 s, 45 s, 60 s, etc.) or returns a processor failure result code 1702c (FIG. 17), then transaction may be routed back to the beginning of the process to try all the steps again and attempt to process the payment transaction with the next payment processor configured (FIG. 10) or according to a rank order 1101 (FIG. 11). If all payment processors are down or unresponsive, or, if other rules or conditions are met such as returning a processor failure result code 1702c (FIG. 17), then the payment transaction may send the payment transaction 1900 to a failover payment processor module 900 (FIG. 9) and save the payment transaction 1900 in a database for future processing at a later point in time. In this regard, the system 100 offers many advantages over the prior art. In particular, the system 100 is able work with multiple third party payment processors 102 including a failover payment processor 900 thereby reducing or eliminating lost sales due to offline or unresponsive third party payment processors 102. Additionally, the payment gateway rules engine 600 allows system 100 users the ability to create custom rules and an active rule 1100 (FIG. 6 and FIG. 11) with said active rule 1100 used to determine which third party payment processor 102 server 300a will be sent the payment transaction 1900 for processing first and in what order (i.e. “first third party payment processor server” 300a1, then “second third party payment processor” server 300a2, then,“third third party payment processor” server, etc.). In some further embodiments, custom rules may be created using a rules creation module (FIG. 11) that will send payment transaction 1900 to a specified third party payment processor 102 based on conditions found within that transaction such as payment transaction dependent variables 1902 (FIG. 19) (e.g. if card type=VISA then use third party payment processor PayPal™)

Referring now to FIG. 6, a flow chart is provided as one example of computer implemented methods and processes which may be performed by gateway rules engine 600 and or translation engines 1500, 800, 1600. Gateway rules engine 600 and translation engines are preferably run by a processor 302 within a server 300 which is preferably local (i.e. on the same server or same server geographic location) to the merchant's payment system 104. According to this high level example, an incoming payment transaction 611 is received from a merchant payment system 104 or an integrated checkout system running on the merchant's website. Payment gateway rules engine 600 finds 601 and loads 602 currently active rule(s) 1100 from one or more plurality of rules 603 created by the user (FIG. 11) who may be the system administrator for the merchant. In some embodiments, each rule has a set rank order 1101 (FIG. 11) comprising information regarding how to select first (or next) 604 payment processor which may further be based on transaction dependent variables 1902 (FIG. 19) found in the incoming payment transaction 1900. A payment transaction detail may contain or otherwise be associated with a history log of all payment processors that attempted to process that particular transaction. Payment gateway rules engine 600 uses selected rule to find first (or next) payment processor 604 from a list of available configured payment processors 605.

In preferred embodiments, once first or next payment processor is found 604, it may be used to process a transaction 606, 608. If transaction is processed successfully 610, then it is returned to the system 100 as a processed transaction 614. If payment processor is down or unresponsive or provides a processor failure result code 1703 (FIG. 17), then transaction is routed back 609 to the beginning of the process to try all the steps again and attempt to process the payment transaction with the next payment processor 604 configured (FIG. 10). If all payment processors are down or unresponsive, or, if other rules or conditions are met, then the payment transaction may be sent to a failover payment processor module 612, 613 and saved in a database for future processing at a later point in time (FIG. 9).

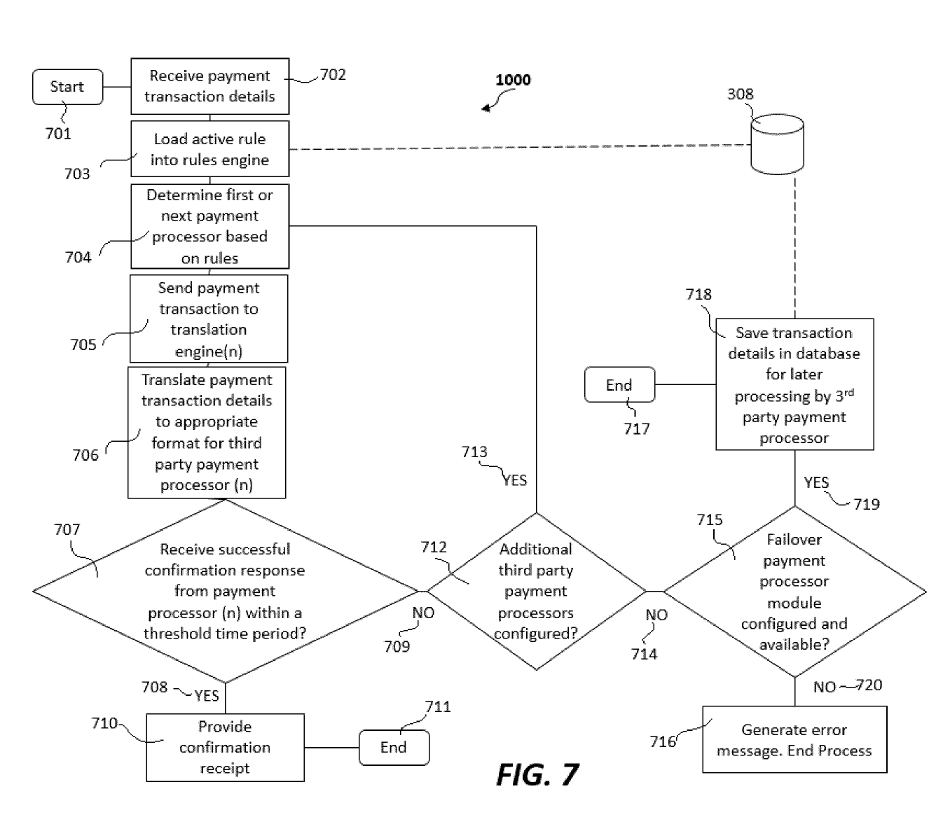

Referring now to FIG. 7, a flow chart is provided as one example of computer implemented methods and processes preferably performed by a processor 302 on a server 300. In particular, FIG. 7 provides one example of processes and steps performed by a payment gateway 1000 of the system 100 said gateway comprising a rules engine 600. According to this high level example, the process starts 701 when incoming payment transaction 1900 is received 702 by the payment gateway in format acceptable (e.g. a second format 1502) that may be read and processed by the engine (sometimes called “second API format”). Next, the rule engine will load 703 an active rule 1100 (FIG. 11) which may be created by the system (i.e. default rules) or by users with a rule creation module 1111 (FIG. 11). In preferred embodiments, only one rule may be active at a given time referred to as the “active rule” 1100. However, in some alternative embodiments, more than one rule may be active and rules engine may load and act on each rule based on a defined order or based on a hierarchy or rules which may be set by the system or customized by each user.

Active rule 1100 will determine 704 and instruct the rules engine 600 which third party payment processor 102 to use first to process payment transactions 1900 (e.g. “first third party payment processor”). If more than one third party payment processors are configured within the system, active rule 1100 may contain a preferred sequence order of first and next third party payment processors to use also referred to as the “rank order 1101” (FIG. 11). Upon determining first third party payment processor to use 704 to process a given transaction, the payment gateway rule engine will send transaction details 705 to the appropriate translation engine 1602, 1603, etc. for that particular payment processor. Translation engine 1602, 1603, etc. is configured to create and translate payment transaction 1900 into an acceptable canonical formatted request 706 which can be received by the determined payment processor 102. Translation engine 1602, 1603, etc. may parse, format, transform, etc. payment details for a variety of third party payment processors 102. In this regard, the system 100 as presented in preferred embodiments is capable of sending payment transactions 1900 to be processed by more than one third party payment processors 102 in plurality of different orders or sequences that may be determined by custom rules created by a user.

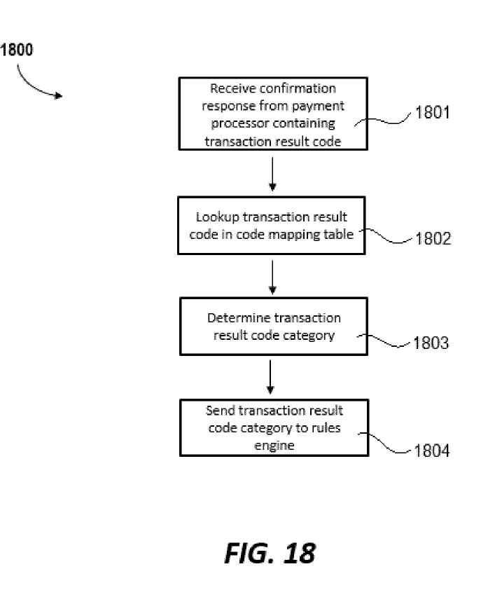

Still referring to FIG. 7, after translation engine transforms payment transaction 1900 into the proper format for the first third party payment processor (e.g. first payment processor(1)) 706, the system will send a request to the processor over a data network preferably the Internet. Upon successful processing 708 of the payment transaction 1900 by the first third party payment processor 102, system 100 will receive a confirmation response 1700 (FIG. 17) back from the third party payment processor within a threshold period of time 707, transform or translate that response into a format accepted by the merchant's user payment module preferably using a code mapping engine (FIG. 18), and provide confirmation receipt 710 to the merchant's payment system 104 whereby merchant's payment system 104 may provide a confirmation receipt to the purchaser of the item and the process may end 711. A “threshold period of time” as used herein is generally a measure of time such as a “timeout value” which may be set by the user during the configuration of a third party payment processor 102 within the system. Non-limiting examples of threshold time periods or sometimes “a period of time” may be 1 second, 2, seconds, 3 seconds, 4 seconds, 5 seconds, 6 seconds, 7 seconds, 8 seconds, 9 seconds, 10 seconds, 15 seconds, 20 seconds, 30 seconds, 45 seconds, or any suitable amount of time. If the system does not receive a successful confirmation response message 709 from the third party payment processor within a threshold period of time, the payment gateway rules engine may next determine if any additional third party payment processors have been configured 712. If additional third party payment processors are configured 713, active rule 1100 may instruct rules engine 600 which third party payment processor 102 should be used next to process payment transaction 1900; the system 100 may use a second translation engine to translate and transform the payment transaction into a canonical format accepted by the second third party payment processor 102. This process may repeat for each additional third party payment processor that is configured within the system until a successful confirmation message 708 is received and the payment transaction has been successfully processed and the process may end 711.

Still referring to FIG. 7, upon trying each configured third party payment processor, or, upon other custom rules which may be setup by the user, the payment gateway rules engine may send 714, 715 the payment transaction 1900 to the failover payment processor module 900 (FIG. 9) which may store 718, 719 the payment transaction 1900 in a database located in a data store 308 for later processing by a third party payment processor 102 at a future point in time and the instant process may end 717. If the system 100 is not configured with a failover payment processor module 720, and the system 100 was unable to process the payment transaction 1900 with the configured third party payment processor(s), the payment transaction processing step may at that time be considered failed and an error message may be generated 716 and sent to the merchant's payment system 104. In preferred embodiments, all payment transactions 1900 and history logs are stored in a database in a data store 308 by the system for report generations, analytics, and other purposes.

Referring now to FIG. 8, a flow chart is provided as one example of computer implemented methods and processes preferably performed by a processor 302 on a server 300. In particular, FIG. 8 provides one example of processes and steps performed by an API conversion module 800. According to this high level example, an incoming payment transaction is first received 801 from merchant payment system 104. The API format used by merchant payment system 104 is analyzed 802 and may be in a format acceptable (i.e. readable) 804 to the payment gateway 1000 in which case the payment gateway 1000 may run its first active rule to determine the appropriate third party payment processor to send the payment transaction to. However, in many instances the API format of the merchant payment system 104 may not be acceptable (i.e. not readable) 803 in its native format by the payment gateway rules engine. In this instance, the API conversion engine will run one or more processes to transform, parse, format, etc. 805 the payment transaction 1900 into the appropriate format (e.g. second API format) that is acceptable by the payment gateway 1000 and send 806 the payment transaction details to the payment gateway 1000.

Referring now to FIG. 9, a flow chart is provided as one example of computer implemented methods and processes which may be performed by a failover payment processor module 900. Failover payment processor module 900 is preferably run by a processor 302 within a server 300 and is configured to work with a database on a data store 308 to store payment transactions 1900 after one or more third party payment processors 102 or all configured third party payment processors 102 were unsuccessful at processing a payment transaction 1900 (i.e. they all received a failure result code or timed out). According to this high level example, once a payment transaction 1900 has been attempted and failed at all configured third party payment processors 101 within the system 100, or, upon other rules which may be setup by the system or user administrator, the payment transaction may be sent to the failover (offline) payment processing module 900 and stored in a database. Failover transaction manager 901 will attempt to load failed transaction 902 from a database and process them with payment gateway rules engine 903 at certain points in the future after waiting for a period of time 907. For example, failover transaction manager may be configured to process payment transactions 10 minutes, 20 minutes, 30 minutes, 60 minutes, 90 minutes, 120 minutes or any suitable amount of time after the last failed transaction attempt, or, at set times (e.g. at midnight daily). Failover transaction manager will send found failed transactions to payment gateway rules engine which in turn will be utilized to determine the appropriate third party payment processor to reprocess each failed transaction 904; (see steps outlined in FIG. 7). If the reprocessing of the transaction has failed 905, the process may repeat itself at a future point in time. If the transaction was successfully processed 906 by one of the third party payment processors 102, a receipt or notification may be sent to customer and the process ends.

FIG. 10 provides an example of a graphical user interface (GUI) of the payment processor configuration module 1010. The payment processor configuration module allows a user (typically the merchant or merchant's system administrator) to configure translation engines 1602, 1603, etc, to allow payment transactions to be sent to a variety of third party payment processors (e.g. PayPal™, Chase™, Litle™, etc.). As shown by this example, pluralities of third party payment processors 102 are available for the system 100 to use (left side of figure). User may select or add the available payment processors to their system 100 by configuring it (selecting the “Configure” button). During the configuration process, the user will typically have to provide account details such as their user id, passwords, identity tokens, etc. to identify that merchant with the chosen third party payment processor. This action will update each respective translation engine 1602, 1603, etc, with the appropriate identifiable details for each merchant and allow each selected and configured third party payment processor 102 to be available to the system 100 and rules engine 600. This provides a clear distinction to the related art in that the system 100 allows merchants to process payment transactions 1900 with more than one third party payment processor 102 in sequence. Also shown by this example, a user may remove a third party payment processor 102 from the list of configured payment processors (right side of figure) by selecting a “Remove” button next to each processor's name or by other suitable means.

FIG. 11 provides an example of a graphical user interface (GUI) of the rule creation module 1111 which may be employed by the system 100. The rule creation module allows a user (typically the merchant or merchant's system administrator) to create, make active, or make inactive one or more rules for use by the payment gateway rules engine 600. Each rule may be stored in a data store 308 on a server 300 or client device 400. For example, rules may be written in software code and stored as binary code file such as a Dynamic-link library file (.dll file) allowing for further customization by each user whereby user may follow documentation to generate any custom rule .dll file and import it into the system 100. In this example, the system 100 is configured to accept a rule name (“Sample Rule One”) and this rule may be made active to become an active rule 1100 or inactive through a checkbox or other suitable means. An active rule 1100 is preferably a type of logic based rule that is made available to the rules engine 600 when processing a payment transaction 1900 while an inactive rule may be stored in the data store 308 but not used by the rules engine 600 when processing a transaction 1900. It should be appreciated to one of ordinary skill in the art that there are many different types and customizations of active rules 1100 which may be created and the examples provided herein are for illustration purposes. In some embodiments, the rules creation module 1111 provides the means for a user to associate a chosen third party payment processor 102 with each rule created. In the example shown by FIG. 11, the user has chosen to use payment processors Litle™, PayPal™, and the failover payment processor module (FIG. 9) with this particular active rule 1100 (e.g. “Sample Rule One”). In preferred embodiments, rule creation module 1111 and active rule 1100 uses a rank order 1101 to set the order in which each third party payment processor 102 will be used by the system 100 to process payment transactions. In the example provided, Litle™ has a rank order of 1 meaning here that it has greater priority 1102 and will be the first third party payment processor 102 used by the system 100 to attempt to process a payment transaction 1900. If system is unsuccessful in processing payment transaction 1900 with the first third party payment processor (e.g. if the first third party payment processor 102 is unresponsive, times out, or returns a processor failure result code 1702c (FIG. 17)), then the next third party payment processor 102 with a lessor priority 1103 in the rank order 1101 may be tried by the system 100 and so on. Finally, upon failure of all configured payment processors 102, the failover payment processor module 900 may be utilized by the system 100 to store the payment transaction 1900 for later processing. In additional embodiments, the user may select a chosen third party payment processor 102 (in the example shown by FIG. 11 PayPal™ is selected) and specify additional payment transaction variables 1901 and payment transaction dependent variables 1902 (FIG. 19) to determine which third party payment processor 102 should be used as the first third party payment processor 102. For example, a user may desire third party payment processor PayPal™ (selected in the example shown by FIG. 11) to be tried only if credit card type is AMEX (selected in the example shown by FIG. 11) although other conditions and criteria may be used to create a rule.

Still referring to FIG. 11, in addition to creating the rank order 1101 for the system 100 to attempt to process payment transactions 1900 with third party payment processors 102, the rules engine 600 and rule creation module 1111 may be adapted to create highly specific and customized active rules 1100 based on various payment transaction variables 1901 or other factors. For example, a user may select certain third payment processors to process transactions between certain dollar amounts or based on certain transactions dates. Likewise, user may select a third party payment processor 102 based on card type (e.g. AMEX or VISA). Some non-limiting examples of some rules and active rules 1100 which may be created and run by the payment gateway rules engine include but are not limited to:

If rank order for PayPal™ (first third party payment processor) is of a greater priority 1102 than rank order for Litle™ (second third party payment processor) which has a lessor priority 1103, then process payment transaction 1900 with PayPal™ first, then, if unsuccessful (e.g. process times out or PayPal™ returns a processor failure result code 1702c) then use Litle™ to process the payment transaction 1900.

If payment amount>$100 then use Litle™

If payment card type=AMEX or VISA then use PayPal™

If product/service ordered=id#1234 then use Chase™

If payment amount is between $100 and $149 AND if transaction date is between Jan. 1, 2014 and Jan. 15, 2014 then use Litle™

It should be noted that these above-mentioned specific transaction variable based rules may be integrated with the ranking order of the selected payment processors. For example, rules may be created to first try payment processor 1, then try payment processor 2, then try payment processor 3 if transaction dollar amount is greater than a defined number. These rules are highly customizable and the examples shown herein should not be used to unintentionally limit the scope of the invention. In preferred embodiments, rules are stored by the system in a data store 308 accessible by a server 300 running the gateway rules engine 600 (FIG. 6).

As perhaps best shown by FIG. 12, an illustrative example of some physical components of system 100 also is presented in accordance with various embodiments of the present invention. In this example, the system 100 may comprise client devices 400 configured to be operated by one or more customers/consumers 101a buying goods or services from merchants, retailers, or users 101b who may also use one or more client devices 400 to access aspects of the system 100. In preferred embodiments, client devices 400 operated by merchants 101b are configured to access payment gateway server 300 running rules engines and modules as described herein. Payment gateway server 300 preferably comprises a database on a data store 308 and is capable of connecting to one or more third party payment processor servers 300a through the Internet or other data network. In some embodiments, payment gateway server 300 runs both the computer implemented methods and processes of the system 100 and provides other payment processing functions for the merchant 101b such as merchant payment system 104 (i.e. methods and processes described herein may be stored in an electronic medium and run locally on merchant's server(s)). In alternative embodiments, payment gateway server 300 and engines/modules of the present invention may be stored and run on a third party server (i.e. software described herein may run in the cloud and not locally to merchant's server).

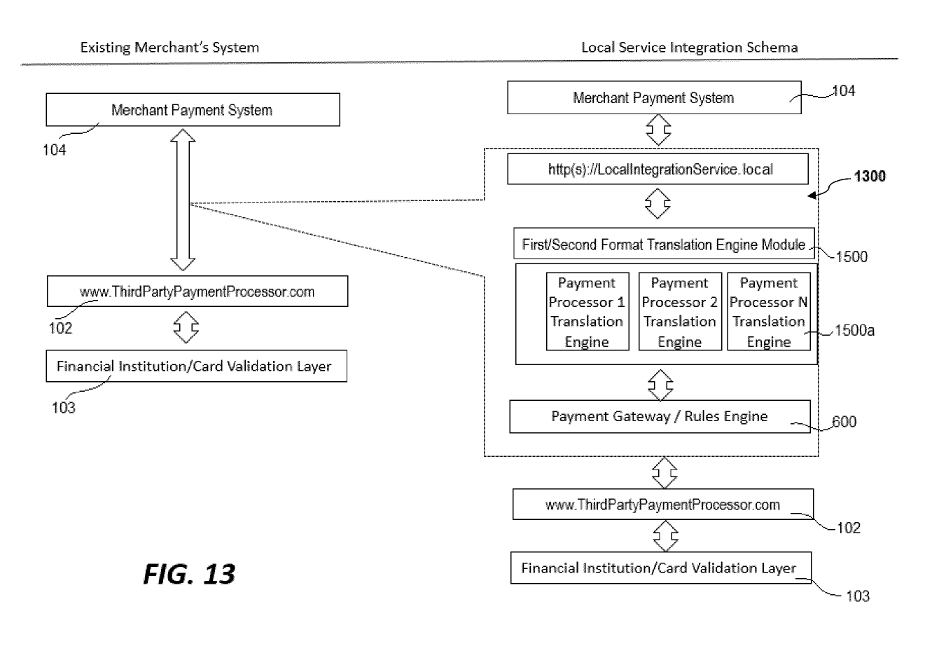

Referring now to FIG. 13, an example of some computer implemented processes according to embodiments of the present invention is provided. In this embodiment, components of the present invention are communicate with merchant's payment system 104 simply by replacing the url pointing to a third party payment processor 102 with a url pointing to a local integration service 1300 which is preferably installed locally on merchant's server. Local integration service 1300 may act as a pseudo payment processor 102; it is responsible for converting payment transaction 1900 requests from a first format 1501 used by merchant payment system 104 to a second format 1502 accepted by payment gateway 1000. Such integration option will allow merchants to integrate the system 100 without any substantial changes to their system and without changing any code. Left side of FIG. 13 outlines integration of any existing merchant payment system 104 with a third party payment processor 102. Merchant payment system 104 has to post payment requests to a service url hosted by a third party payment processor 102 (for example for PayPal™ it is “pilot-payflowpro.paypal.com”). Third party payment processor 102 in turn formats and sends payment request to appropriate financial institution (VISA™, MasterCard™, etc).

Right side of FIG. 13 outlines integration of merchant payment system 104 with the payment gateway 1000 using a novel local integration service 1300. Merchant payment system 104 can be integrated with payment gateway 1000 by replacing a third party payment processor url (tpp_url) with a url pointing to local integration service 1300 (url_local) installed on the merchant's server 300. Local integration service 1300 comprises computer implemented programs and processes responsible for accepting payment transaction requests intended for third party payment processors 102 and using a first/second translation engine module 1500 or similar processes to convert and transform the request which may come in a first format to a second format acceptable by the payment gateway 1000. The first/second translation engine module 1500 may comprise one or more payment processor translation engines 1500a with each payment processor translation engine 1500a configured to translate requests from disparate third party payment processors to a format readable by the payment gateway 1000 and rules engine 600. In some embodiments, the local integration service 1300 may replace or be in addition to the API conversion engine 800 (FIG. 8).

Referring now to FIG. 14, an example of some computer implemented processes according to embodiments of the present invention is provided. In this embodiment, components of the system 100 communicate with a merchant's payment system 104 through a variety of API formats. Merchant may choose one of the supported APIs and write integration code to integrate with payment gateway 1000. API conversion engine 800 (FIG. 8) contains a number of most widely used integration APIs. Left side of FIG. 14 outlines integration of any existing merchant payment system 104 with a third party payment processor 102. Merchant payment system 104 has to post payment requests to a service url hosted by a third party payment processor (for example for PayPal™ it is currently “pilot-payflowpro.paypal.com”). Third party payment processor 102 in turn formats and sends payment request to appropriate financial institution (VISA, MasterCard, etc). Right side of the slide outlines integration of merchant payment system 104 with payment gateway 1000 as described in some embodiments herein thru API conversion engine 800 (FIG. 8). This may be a preferred option for integration with new merchant payment system 104 that are not integrated with any third party payment processors yet. Merchant payment system 104 may interact with API conversion engine 800 thru a number of supported APIs. If merchant payment system 104 uses the same technology/programming language as payment gateway then no conversion may be needed as merchant payment system 104 will directly communicate with the payment gateway 1000; otherwise API conversion engine 800 will translate from a first format used by merchant payment system 104 to a second format used by payment gateway 1000.

Referring now to FIG. 15, an example of some computer implemented processes according to embodiments of the present invention is provided. In this embodiment, components of the present invention are accessed by merchant's payment system 104 simply by replacing the url of a third party payment processor (url_tpp) 1501a with a local url or third party url pointing to local integration service (url_local) 1501b to accept and facilitate the processing of payment transactions 1900 from a variety of first formats 1501 without the need for the merchant to add additional code or make substantial changes to their payment system. By way of non-limiting example, if merchant payment system 104 uses third party payment processor1 which is accessed thru a url_tppp 1501a such as https://www.PaymentProcessor1.com (for example) then merchant can replace this url_tpp 1501a with url_local 1501b such as https://LocalIntegrationService.local to transmit the payment transaction 1900 to the local integration service 1300. Local integration service is a local service 1300 may be installed locally on merchant's server(s) 300; it is able to accept web requests and return responses for all supported third party payment processors 102. Local integration service 1300 is able to determine for which third party payment processor 102 request is intended, then use a first/second translation engine module 1500 or similar means to translate, parse, and otherwise transform the payment transaction request from a first format 1501 into a second format 1502 supported by payment gateway 1000. Upon receiving a confirmation response 1700 (FIG. 17) from a third party payment processor server 300a, the first/second translation engine module 1500 may transform the confirmation response 1700 back to a first format 1501 expected by the merchant payment system 104 system. For example, local integration service may interact with the system 100 in the following embodiment:

1. Receive web payment transaction request for third party payment processor (e.g. PayPal™) in a first format 1501.

2. Use first/second translation engine module 1500 to transform request to payment gateway format (second format 1502).

3. Run rules engine and send payment request to PayPal™ and receive confirmation response 1700 from PayPal.

4. Use first/second translation engine module 1500 to transform response back to PayPal™ response format (first format 1501) and return it to the merchant payment system 104. In this regard, merchant's payment system believes it is processing payments directly with PayPal™ or a previously configured third party payment processor 102 and merchant is able to enjoy benefits of the system 100 without extensive setup or changing code on their existing payment system.

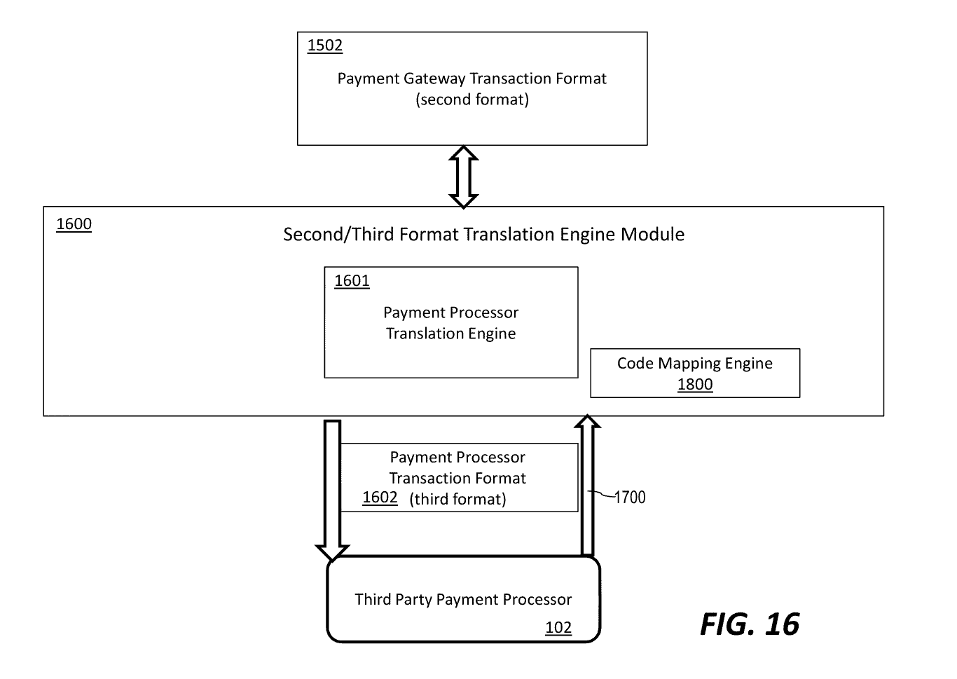

Referring now to FIG. 16, an example of some computer implemented processes according to embodiments of the present invention is provided. In this example, a second/third format translation engine module 1600 is used to translate, parse, modify, or otherwise transform payment transaction 1900 into the appropriate format (e.g. third format 1602) acceptable by a selected third party payment processor 102. In this regard, the system 100 can communicate with disparate third party payment processors 102. Second/third format translation engine module 1600 is able to convert transactions in two directions either from third party payment processor format (third format 1602) to payment gateway format (second format 1502) readable by the payment gateway 1000 or from payment gateway second format 1502 to any supported third party payment processor third format 1602. Second/third format translation engine module 1600 preferably contains a separate translation engine 1601 with unique rules and code for each supported third party payment processor 102. Also shown by FIG. 16, an example of a code mapping engine 1800 (FIG. 18) is provided. Code mapping engine 1800 preferably resides within or communicates with second/third format translation engine module 1600 providing a means for the payment gateway 1000 to understand disparate result codes 1702 provided by each third party payment processor 102.

Referring now to FIG. 17A, 17B, and 18. FIG. 17A. FIG. 17A provides an example of a confirmation response 1700 as may be provided by a third party payment processor 102 to the system 100. The transaction confirmation response 1700 preferably comprises one or more codes such as a transaction result code 1702 used by the system 100 to determine if a payment transaction was processed successfully or not. Transition result code 1702 is preferably an alphanumeric short string of characters and each third party payment processor 102 may use a different code string to indicate a different result. FIG. 17B provides an example of a confirmation response code mapping table 1710 as may be used by the system 100 to classify transaction result codes 1702 into a transaction result code category 1701 for further processing by the payment gateway 1000. In this example four transaction result code categories 1701 are provided as approved 1701a, manual review 1701b, processor failure 1701c, and declined 1701d. In preferred embodiments, the transaction result codes 1702 which indicate processor failure 1701c are of particular interest and are indicated as processor failure result codes 1702c. It should be noted that each third party payment processor 102 may have their own unique processor failure result code 1702c or set of processor failure result codes 1702c thereby the importance of the mapping engine 1800 (FIG. 18) should be readily understood to one of ordinary skill in the art allowing the system 100 to read and understand multiple processor failure result codes 1702c from disparate third party payment processors 102. In general, the processor failure result codes 1702c indicate that the third party payment processor selected by the rules engine 600 is down, unresponsive, or otherwise unable to process payment transactions 1900 at that time. Typically when the payment gateway 1000 receives a processor failure result code 1702c from the code mapping engine 1800 or through the second/third format translation engine module 1600, it will trigger the rules engine 600 to try the a second or lessor priority third party payment processor 102 configured within the system 100 or even send the payment transaction 1900 to the failover payment processor module 900 if configured. FIG. 18 provides one example of a computer implemented methods and processes which may be run by a code mapping engine 1800. In this example, code mapping engine 1800 first receives 1801 a confirmation response 1700 from a third party processor 102 wherein the confirmation response 1700 contains a transaction result code 1702. Next, the mapping engine 1800 looks up 1802 or references the transaction result code 1702 in the code mapping table 1710 to determine 1803 the transaction result code category 1701 for the result code 1702. Finally, the mapping engine 1800 may send 1804 the transaction result code category 1701 to the rules engine 600 for further processing. By way of example, if the transaction code category 1701 is “approved 1701a” then the rules engine 600 will note this payment transaction 1900 was processed successfully and report this to the merchant's payment system 104. Alternatively, if the transaction code category 1701 is processor failure result code 1701c, the rules engine 600 may use active rule 1100 comprising a rank order 1101 to determine a next or second third party payment processor 102 to send the payment transaction 1900 to.

FIG. 19 provides an example of a payment transaction 1900 which may be received by the system 100 from a merchant's payment system 104. The payment transaction 1900 shall generally refer to data which includes multiple transaction dependent variables 1902 about a particular customer's purchase from a merchant. Payment transaction variables 1901 may include but are not limited to information such as; transaction id number 1901a, customer name, customer billing address including customer country 1901f, customer credit or debit card type (e.g. Visa, MasterCard, AMEX, etc.) 1901c, credit or debit card number 1901d, credit or debit card expiration, date, credit or debit card security code, transaction amount 1901e, transaction date, item/product number, etc. Payment transactions 1900 are preferably stored in a database on a data store 308 on a server 300 and may be accessed by the system 100.

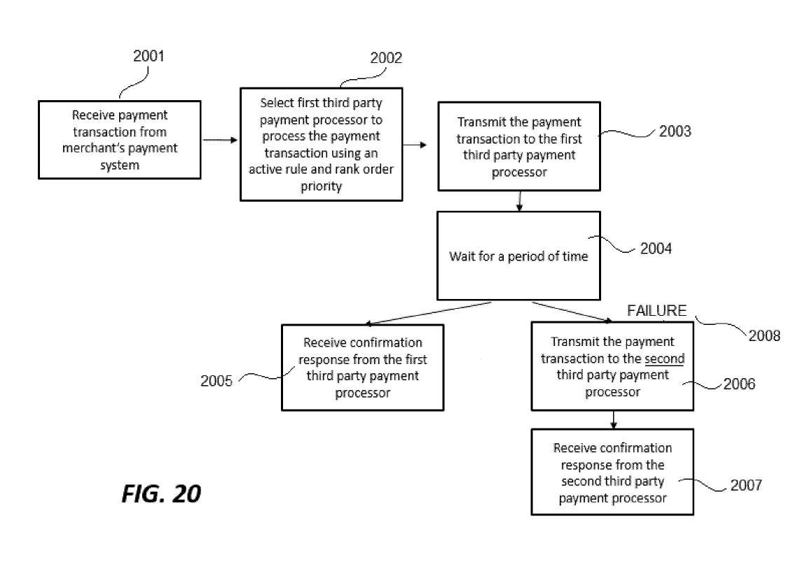

Referring now to FIG. 20, a high level overview of some embodiments of the system 100 and in particular some computer implemented programs 316 which may be run on a processor 302 on a server 300 are illustrated. In this example, payment transaction details 1900 are first received 2001 from a merchant's payment system 104. Next, the payment gateway 1000 or rules engine 600 may select 2002 a first third party payment processor 102 using an active rule 1100 containing a rank order 1101 to process the payment transaction 1900. Then, the payment transaction 1900 is transmitted 2003 to the first selected third party payment processor 102, the system 100 and payment gateway 1000 may next wait for either a period of time 2004 (also called a “timeout period”) which may be any suitable amount of time (e.g. 10 s, 20 s, 30 s, 45 s, 60 s) or, wait to see if the selected third party payment processor returns a processor failure result code 1702c if one of either (timeout or failure code) occurs, the system 100 would determine a “failure” 2008 with the payment transaction 1900 with that first third party payment processor 102. Upon failure 2008, the system 1000 and in particular the rules engine 600 would use the active rule 1100 to determine the second third party payment processor 102 and transmit 2006 payment transaction 1900 to the second third party payment processor 102 which, in preferred embodiments, has a lessor priority 1103 in the rank order 1101 of the active rule 1100 used by the rules engine 600 (i.e. the transaction is sent to the next payment processor listed in the active rule). Finally, a confirmation response 1700 is received 2007 from the second third party payment processor 102.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium (wherein said medium is not a transitory wave or signal) having computer readable code stored thereon for programming a computer, server, appliance, device, etc. each of which may include a processor to perform methods as described and claimed herein. Examples of such computer-readable storage mediums (wherein said medium is not a transitory wave or signal) include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

### REFERENCES (INCORPORATED HEREIN BY REFERENCE)

U.S. Pat. No. 8,543,508

What is claimed is:

1. A computer implemented payment processing system, the system configured to:
a. receive a payment transaction from a merchant's payment system;
b. select a first third party payment processor or a second third party payment processor to process the payment transaction using an active rule;
c. transmit the payment transaction to the first third party payment processor server selected by the active rule;
d. receive a confirmation response from the first third party payment processor server; and
whereby the merchant's payment system is therefore able to send and receive payment transactions with disparate first and second third party payment processors.

2. The system of claim 1, wherein the active rule is run by a rules engine.

3. The system of claim 1, wherein the active rule comprises a rank order of third party payment processors.

4. The system of claim 1, wherein the active rule is configured to select a first third party payment processor based on a rank order of said first third party payment processor.

5. The system of claim 1, wherein the system selects a first third party payment processor based on a first payment transaction variable.

6. The system of claim 5, wherein the system selects a second third party payment processor based on the first payment transaction variable.

7. The system of claim 6 wherein the first payment transaction variable is selected from one of: card type, transaction amount, and country.

8. The system of claim 1, wherein the active rule comprises a rank order of third party payment processors allowing the system to transmit the payment transaction to a first third party payment processor, wait for a period of time, then transmit the payment transaction to a second third party payment processor wherein said first third party payment processor has a rank order of greater priority than the rank order of the second third party payment processor.

9. The system of claim 1, wherein the active rule comprises a rank order of third party payment processors allowing the system to transmit the payment transaction first to a first third party payment processor, then if a processor failure result code received from said first third party payment processor, transmit the payment transaction to a second third party payment processor.

10. The system of claim 1, further comprising an API conversion engine configured to accept the payment transaction from merchant payment system in a first format and translate the payment transaction from the first format to a second format.

11. The system of claim 1, wherein the system receives the payment transaction through a uniform resource locator of a local integration service (URL_local) running on a merchant's server thereby allowing the system act as a pseudo payment processor to receive payment transactions from merchant's payment system without the need for substantial coding changes.

12. A computer implemented payment processing system, the system comprising computer implemented methods to:
a. receive a payment transaction from a merchant's payment system;
b. select a first third party payment processor to process the payment transaction,
c. transmit the payment transaction to the first third party payment processor;
d. determine if there was a failure with the first third party payment processor;
e. transmit the payment transaction detail to a second third party payment processor if the first third party payment processor had a failure or was otherwise unable to receive the payment transaction.

13. The system of claim 12, wherein the first third party payment processor is selected based on a rank order.

14. The system of claim 13, where the second third party payment processor is selected based on a rank order of lessor priority then the first third party payment processor.

15. The system of claim 12, wherein the method of selecting a first third party payment processor is determined by a rule.

16. The system of claim 12, further comprising transmitting the payment transaction to all configured third party payment processors and receiving a failure for each of said all configured third party payment processors and then finally transmitting the payment transaction to a failover payment processor module.

17. The system of claim 12, further comprising an API conversion engine configured to accept the payment transaction from merchant payment system in a first format and translate the payment transaction from the first format to a second format.

18. The system of claim 12, wherein the system receives the payment transaction through a uniform resource locator of a local integration service (URL_local) thereby allowing the system act as a pseudo payment processor to receive payment transactions from merchant's payment system without the need for substantial coding changes.

19. The system of claim 12, further comprising a code mapping engine, wherein the code mapping engine;
a. receives a confirmation response containing a transaction result code;
b. references the transaction result code to determine a transaction result code category; and
c. transmits the transaction result code category to a payment gateway to determine if the second third party payment processor should be called upon to process the payment transaction, or, if the payment transaction should be transmitted to the merchant's payment system.

20. A payment gateway system configured to allow disparate merchant payment systems to send and receive payment transactions with a plurality of third party payment processors, the system comprising;
a. a local integration service adapted to receive a payment transaction from a merchant's payment system in a first format and translate the payment transaction to a second format readable by a rules engine;
b. a rules engine configured to run a plurality of logic based rules and selectively determine a third party payment processor to receive the payment transaction; and
c. a code mapping engine configured to receive a plurality of payment processor transaction result codes from disparate third party payment processors and determine a transaction result code category for a transaction result code and transmit said transaction result code category to the rules engine for further processing.
